(19) United States
(12) Patent Application Publication
(10) Pub. No.: US 2007/0006858 A1
(43) Pub. Date: Jan. 11, 2007

(54) Method for producing an individual ignition coil and coil thus obtained

(76) Inventor: Francois Fontalba, Lyon (FR)

Correspondence Address: DENNISON, SCHULTZ & MACDONALD, 1727 KING STREET, SUITE 105, ALEXANDRIA, VA, 22314, US

(21) Appl. No.: 10/557,546

(22) PCT Filed: May 19, 2004
(86) PCT No.: PCT/FR04/01239

§ 371 Date: Jan. 1, 2006

(30) Foreign Application Priority Data
May 22, 2003 (FR) 03/06132

(51) Int. Cl. H01F 38/12; H01F 27/00

(52) U.S. Cl. 123/634; 29/606; 336/90; 336/107

(57) ABSTRACT

The invention relates to a method for manufacturing an individual ignition coil for a spark plug (2) of a controlled ignition and internal combustion heat engine, including the following steps: coiling a secondary winding (15) on a secondary coil tubular body (11),
coiling a primary winding (23) concentrically and externally relatively to the secondary winding (15) while being electrically insulated relatively to the latter by means of a dielectric material.

According to the invention, it includes a step for overmolding the tubular body (11)/secondary winding assembly (15) with a dielectric material providing impregnation of the secondary winding and formation of a primary coil tubular body (21) adapted for allowing during a subsequent step, the coiling of the primary winding (23) on the one hand, and of an end piece for connection (21₁) to a spark plug extending the primary coil tubular body (21) at one of its ends, on the other hand.

The present invention relates to the technical field of internal combustion heat engines and more particularly to engines with ignition controlled via spark plugs.

More particularly, the invention is directed to ignition systems wherein each ignition spark plug is fitted out with an electric power transformation unit coil capable of supplying it from a low voltage electric power source, with high voltage power required for producing an ignition spark between the electrodes of such a spark plug inside the combustion chamber of the cylinder.

In the state of the art, many alternative embodiments of an ignition unit coil are known. Generally, an ignition coil includes a secondary coil body or tubular carcass, made in dielectric material and internally including a central magnetic core and on its external face, a secondary winding. One of the terminals of the secondary winding is connected to means for electrically cooperating with the connecting terminal of the spark plug. This secondary coil/tubular body assembly is inserted into a primary tubular carcass on the external face of which is coiled a primary winding connected to a low voltage connector. The primary winding is surrounded via a magnetic cylinder providing the sealing off of the flux with the magnetic core. Conventionally, the thereby formed coil or a portion of the constituent parts are impregnated with a dielectric resin during a casting operation in vacuo.

Such an ignition coil is intended to be inserted in a well provided in the cylinder head and at the bottom of which an ignition spark plug is housed. Such coils are subject to high temperatures and vibrations and should have optimized insulation in a limited diametral bulk volume.

It should be considered that this type of coil has a relatively large number of constituent parts, the assembly of which should be performed accurately and carefully in order to guarantee the reliability of the coil. In the same sense, assembling these different parts requires fitting areas which create interfaces capable of breaking the dielectric insulation promoting high voltage tracking.

Moreover, it should be considered that impregnation performed in vacuo requires large passage sections enabling the relatively viscous resin to flow by gravity between the different constituent parts before atmospheric pressure is re-established around the coil and will compact the resin towards areas which are still empty. Moreover, polymerisation of the resins used for this type of application requires ovens for gelling and polymerisation in which the coils must stay for several hours. Moreover, nesting of the different constituent parts and of the resin poses mechanical stress problems, in particular during heat cycles, due to differences in the expansion coefficient of the materials in presence.

In order to notably attempt to reduce the diametral bulkiness of such a coil, Patent EP 0 843 394 suggests making an ignition coil which does not include any primary tubular carcass. Indeed, a dielectric resin which coats the secondary coil after hardening is used for coiling up the primary winding. However, the lack of a primary tubular carcass makes the coiling operation delicate for the primary winding. Moreover, such an ignition coil does not provide a solution to the problem related to the presence of interfaces capable of breaking the dielectric insulation promoting high voltage tracking. Furthermore, the drawbacks stated above relating to the application of resins remain unsolved for such an ignition coil.

Therefore the present invention is directed to finding a remedy for the drawbacks stated above by proposing a new technique for manufacturing an integrated coil for individual ignition, designed in order to facilitate manufacturing operations while securely and effectively providing dielectric insulation between the different constituent parts.

Another object of the invention is directed to proposing a method with which a new integrated coil for individual ignition may be obtained, designed in order to have optimized insulation in a reduced diametral space.

In order to achieve such a goal, the method includes the following steps:
coiling a secondary winding on a secondary coil tubular body,
coiling a primary winding concentrically and externally relative to the secondary winding, while being electrically insulated from the latter by means of a dielectric material.

According to the invention, the method is characterized in that it includes a step for overmolding the tubular body (11)/secondary winding (15) assembly with a dielectric material providing impregnation of the secondary winding and formation of a primary winding tubular body (21) adapted so as to allow during a subsequent step, the coiling of the primary winding (23), on the one hand, and an end piece for connection (21₁) to a spark plug extending the primary coil tubular body (21) at one of its ends, on the other hand.

According to another preferred embodiment feature, the method during the overmolding step, consists of providing formation of a primary coil tubular body, provided at the end opposite to the one fitted with the end piece, with means adapted for receiving low voltage electrical connections.

Advantageously, the method according to the invention during the overmolding step consists of closing up the bore of the secondary winding tubular body.

The method according to the invention also includes a step for mounting a magnetic core inside the bore of the secondary coil tubular body.

The method according to the invention also includes a step for mounting a cylinder for sealing off the magnetic flux with the magnetic core mounted externally to the primary winding.

Advantageously, the method consists of providing the overmolding step, by pressurized injection of a thermosetting dielectric material inside a mold.

Another object of the invention is to propose a coil including at least one secondary coil tubular body bearing on its external face, a secondary winding and a tubular body in an overmolded dielectric material on the secondary winding thereby providing impregnation of the secondary winding, the overmolded tubular body being extended at one end by an end piece adapted for connection to a spark plug.

According to another preferred embodiment feature, the overmolded tubular body includes at its end opposite to the one provided with the end piece, means adapted for receiving low voltage electrical connections.

Finally, the integrated ignition coil according to the invention includes an overmolded tubular body bearing on its external surface, a primary winding on the outside of which is mounted a cylinder for sealing off the magnetic flux with a magnetic core inserted inside the tubular body.

Various other features will become apparent from the description made below with reference to the appended drawings which show, as non-limiting examples, embodiments of the object of the invention.

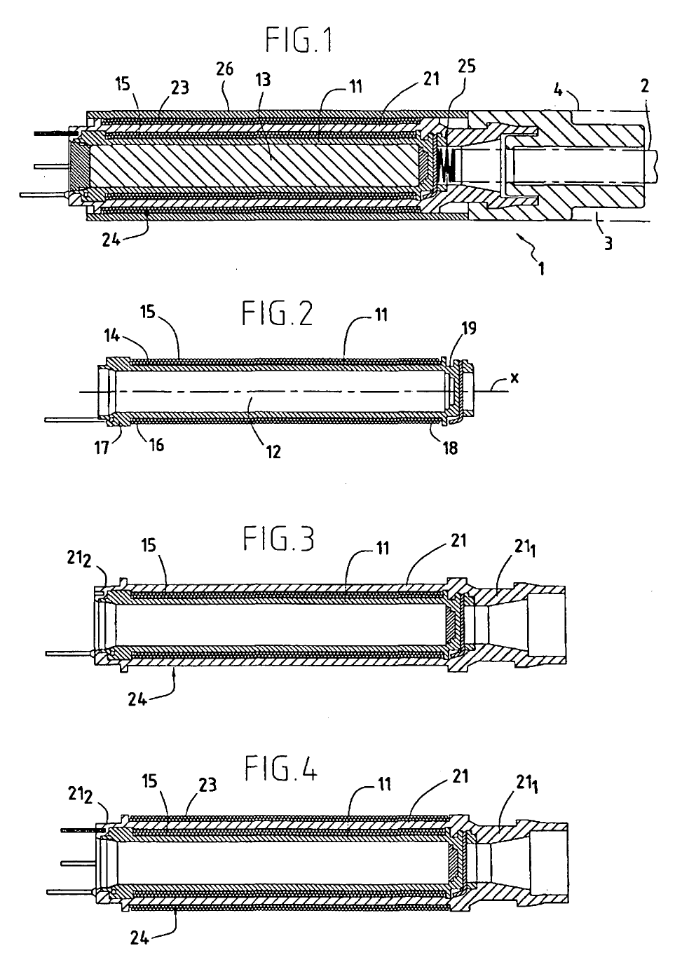

FIG. 1 is a longitudinal sectional view of an exemplary embodiment of an integrated ignition coil according to the invention.

FIGS. 2, 3 and 4 are longitudinal sectional views showing different characteristic steps of the method for manufacturing an ignition coil according to the invention.

As this emerges from FIG. 1 more specifically, the ignition coil 1 according to the invention is intended to provide an individual electrical power supply for a spark plug 2 of a heat engine illustrated simply schematically and set up at the bottom of a well 3 of a cylinder head 4 of such an engine. The coil globally designated by reference 1, is intended to be mounted so as to be interposed between the spark plug 2 and an ignition system known to one skilled in the art, capable of controlling the coil in order to generate a high voltage current towards the spark plug 2.

FIGS. 2-4 illustrate different characteristic steps of the method for manufacturing an ignition coil 1 according to the invention.

As this emerges from FIG. 2 more specifically, the coil 1 includes a secondary coil tubular carcass or body 11 made in a dielectric material, for example in a thermoplastic or thermosetting material. For example, this secondary carcass 11 is made by molding, by injecting a thermoplastic or thermosetting material. This tubular carcass 11 includes a central bore 12 with a longitudinal axis x intended to receive a magnetic core 13 for example formed with a sheeted mass directed along the longitudinal axis x.

The secondary carcass 11 is delimited by an external face of revolution 14 intended to receive a secondary winding 15 having a low voltage end 16 located relatively to a terminal portion 17 of the secondary carcass 11 and a high voltage end 18 located at a terminal portion 19 of the secondary carcass 11, located oppositely to the other terminal portion 17. These steps for making the secondary carcass 11 and coiling a secondary winding on the secondary carcass 11 are not described more specifically as they are well known to one skilled in the art.

According to a feature of the invention illustrated in FIG. 3, the method consists of then applying a step for overmolding the secondary carcass 11/secondary winding 15 assembly, with a dielectric material providing impregnation of the secondary winding 15 and the formation of a carcass or primary coil tubular body 21 adapted to allow during a subsequent step, the coiling of a primary winding 23. The method according to the invention thus consists of providing pressurized injection of a preferably thermosetting dielectric material in an overmolding mold. Such a dielectric material provides impregnation of the turns of the secondary winding 15 as well as a high voltage insulation function for the secondary coil. Further, overmolding of this dielectric material is achieved in order to obtain a primary carcass 21 used as a support for the primary coil. This primary carcass 21 thus extends concentrically to the secondary carcass 11 and to the outside of the secondary winding 15 along at least the whole length of the secondary winding taken along the x axis.

According to an advantageous feature of the method according to the invention, this overmolding step is utilized so that the primary carcass 21 has conformations in order to assume additional functions such as mechanical assembly and/or electrical connection functions.

According to an advantageous feature of the object of the invention, the method consists of providing during this overmolding step, formation of a primary carcass 21 extending to one end, with an end piece 21, for connecting to a spark plug which fits into the inside of the end piece 21₁. Of course, the end piece 21, integrates electrical connection means in order to form a high voltage terminal 25 of the ignition coil. In the example illustrated in FIG. 1, the high voltage terminal 25 is formed by a high voltage tab on which a spring is mounted.

According to another advantageous embodiment feature, during this overmolding step, provision may be made for ensuring formation of a primary carcass 21 provided at the end opposite to the one fitted with the end piece 21₁, of an extension 21₂ provided with means adapted for receiving low voltage electrical connections. Such an extension 21₂ may thereby form a low voltage connector.

Thus, by overmolding the primary carcass 21, it is possible to limit the number of constituent parts of the ignition coil by the fact that the shape given to the overmolding mold may itself fulfil the functions usually fulfilled by various parts. With this overmolded primary carcass 21 which forms a single part, it is possible to suppress the interfaces between various parts which may facilitate high voltage tracking.

According to a preferred embodiment feature, during this overmolding step, the bore 12 of the secondary carcass 11 is sealed off so that the magnetic core may be mounted subsequently.

After the overmolding step, provision may be made for performing a step for coiling a primary winding 23 on the external face 24 of the primary carcass 21 as this appears in FIG. 4 more specifically.

The method according to the invention is then directed to implementing a step for mounting a cylinder 26 for sealing off the magnetic flux with the magnetic core 13, externally mounted to the primary winding 23.

With the manufacturing method according to the invention, it is possible to reduce the number of constituent parts of an ignition coil thereby facilitating assembly operations. With this reduction in the number of parts, it is possible to suppress the interfaces, and consequently, the breakdown faults between the high voltage terminal 25 and the seal-off cylinder 26, and between the high voltage terminal 25 and the primary coil 23. Moreover, insofar that the magnetic core 13 is not embedded in a resin, this magnetic core 13 may freely expand depending on the temperature without causing cracking of the secondary carcass 11.

The invention is not limited to the described and illustrated examples as various changes may be made thereto without departing from its scope.

1. A method for manufacturing an individual ignition coil for a spark plug (2) of a controlled ignition and internal combustion heat engine, including the following steps:
coiling a secondary winding (15) on a secondary coil tubular body (11),
coiling a primary winding (23) concentrically and externally relatively to the secondary winding (15), while being electrically insulated relatively to the latter by means of a dielectric material,
characterized in that it includes a step for overmolding the tubular body (11)/secondary winding (15) assembly with a dielectric material providing impregnation of the secondary winding and formation of a primary winding tubular body (21) adapted for allowing, during a subsequent step, coiling of the primary winding (23) on the one hand, and an end piece for connection (21₁) to a spark plug extending the primary coil tubular body (21) at one of its ends on the other hand.

2. The method according to claim 1, characterized in that during the overmolding step, it consists of ensuring formation of a primary coil tubular body (21), provided at the end opposite to the one fitted with the end piece with means (21₂) adapted for receiving low voltage electrical connections.

3. The method according to claim 1, characterized in that during the overmolding step, it consists of closing up the bore (12) of the secondary coil tubular body (11).

4. The method according to claim 1, characterized in that it includes a step for mounting a magnetic core (13) inside the bore (12) of the secondary coil tubular body (11).

5. The method according to claim 1, characterized in that it includes a step for mounting a cylinder for sealing off the magnetic flux (26) with the magnetic core (13), externally mounted to the primary winding (23).

6. The method according to claim 1, characterized in that it consists of providing the overmolding step, by pressurized injection of a thermosetting dielectric material inside a mold.

7. An individual integrated ignition coil for a spark plug of a controlled ignition and internal combustion heat engine, including at least one secondary coil tubular body (11) bearing on its external face (14), a secondary winding (15), characterized in that it includes a tubular body (21) in a dielectric material overmolded on the secondary winding (15) also providing impregnation of the secondary winding, the overmolded tubular body (21) being extended at one end by an end piece (21₁) adapted for connection to a spark plug.

8. The individual integrated ignition coil according to claim 7, characterized in that the overmolded tubular body (21) includes at its end opposite to the one provided with the end piece (21₁), means (21₂) adapted for receiving low voltage electrical connections.

9. The individual integrated ignition coil according to claim 7, characterized in that the overmolded tubular body (21) bears on its external surface (24) a primary winding (23) outside which a cylinder (26) is mounted for sealing-off the magnetic flux with a magnetic core (13) inserted inside the tubular body (11).
